(19) United States
(12) Patent Application Publication
(10) Pub. No.: US 2015/0063208 A1
(43) Pub. Date: Mar. 5, 2015

(54) SYSTEMS AND METHODS FOR SERVICE IDENTIFICATION IN NEIGHBORHOOD AWARE NETWORKS

(71) Applicant: QUALCOMM Incorporated, San Diego, CA (US)

(72) Inventors: Santosh Paul Abraham, San Diego, CA (US); Alireza Raissinia, Monte Sereno, CA (US); George Cherian, San Diego, CA (US)

(21) Appl. No.: 14/465,740

(22) Filed: Aug. 21, 2014

Related U.S. Application Data
(60) Provisional application No. 61/871,138, filed on Aug. 28, 2013.

(51) Int. Cl. H04W 8/02; H04W 84/10

(52) U.S. Cl. CPC H04W 8/02; H04W 84/10
USPC 370/328

(57) ABSTRACT

Systems and methods in accordance with various embodiments provide for robust service IDs for utilization in wireless devices in neighbor aware networks. In certain embodiments, a service ID is generated as a hash value from a diversified input string. One aspect of the subject matter described in the disclosure provides a method of transmitting service information in a wireless neighborhood aware network. The method includes generating, via a wireless device, a message including a hash value of a data string, the data string including both a name of a service and information identifying a type of the message. The message further includes a matching filter field including matching filter information that characterizes the service named in the data string. The method further includes transmitting the message.

### CROSS-REFERENCE TO RELATED APPLICATIONS

The present application claims priority to provisional U.S. Application Ser. No. 61/871,138, entitled “Systems and Methods for Service Identification in Neighborhood Aware Networks,” filed Aug. 28, 2013, assigned to the assignee hereof and is hereby expressly incorporated herein by reference in its entirety.

### BACKGROUND

1. Field

The present application relates generally to wireless communications, and more specifically to systems, methods, and devices for service identification in a neighborhood aware networks (NAN)

2. Background

In many telecommunication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), a neighborhood aware network (NAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

Devices in a wireless network can transmit and/or receive information to and from each other. To carry out various communications, the wireless devices can coordinate according to a protocol. As such, wireless devices can exchange information to coordinate their activities. Improved systems, methods, and wireless devices for coordinating transmitting and sending communications within a wireless network are desired.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include improved efficiency when introducing devices on a medium.

One aspect of the subject matter described in the disclosure provides a method of transmitting service information in a wireless neighborhood aware network. The method includes generating, via a wireless device, a message including a hash value of a data string, the data string including both a name of a service and information identifying a type of the message. The message further includes a matching filter field including matching filter information that characterizes the service named in the data string. The method further includes transmitting the message.

Another aspect of the subject matter described in the disclosure provides a method of receiving service information in a wireless neighborhood aware network. The method includes receiving, via a wireless device, a message that includes a hash value of a data string, the data string including both a name of a service and information identifying a type of the message. The message further includes a matching filter field including matching filter information that characterizes the service named in the data string. The method further includes identifying a service from the hash value.

Another aspect of the subject matter described in the disclosure provides an apparatus for transmitting service information in a wireless neighborhood aware network. The apparatus includes a processor configured to generate a message, wherein the message includes a hash value of a data string that includes both the name of a service and information identifying the type of the message. The message further includes a matching filter field including matching filter information that characterizes the service named in the data string. The apparatus further includes a transmitter configured to transmit the message.

Another aspect of the subject matter described in the disclosure provides an apparatus for receiving service information in a wireless neighborhood aware network. The apparatus includes a receiver configured to receive a message including a hash value of a data string, the data string including both a name of a service and information identifying a type of the message. The message further includes a matching filter field including matching filter information that characterizes the service named in the data string. The apparatus further includes a processor configured to use the hash value to identify the service.

Another aspect of the subject matter described in the disclosure provides an apparatus for transmitting service information in a wireless neighborhood aware network. The apparatus includes a means for generating a message including a hash value of a data string, the data string including both a name of a service and information identifying a type of the message. The message further includes a matching filter field including matching filter information that characterizes the service named in the data string. The apparatus further includes a means for transmitting the message.

Another aspect of the subject matter described in the disclosure provides an apparatus for receiving service information in a wireless neighborhood aware network. The apparatus includes a means for receiving a message that includes a hash value of a data string, the data string including both a name of a service and information identifying a type of the message. The message further includes a matching filter field including matching filter information that characterizes the service named in the data string. The apparatus further includes a means for identifying a service from the hash value using the receiver device.

Another aspect of the subject matter described in the disclosure provides non-transitory computer-readable medium including code that, when executed, causes an apparatus to: generate a message including a hash value of a data string, the data string including both a name of a service and information identifying a type of the message. The message further includes a matching filter field including matching filter information that characterizes the service named in the data string. The medium further includes code that, when executed, causes the apparatus to transmit the message.

Another aspect of the subject matter described in the disclosure provides a non-transitory computer-readable medium including code that, when executed, causes an apparatus to: receive a message that includes a hash value of a data string, the data string including both a name of a service and information identifying a type of the message. The message further includes a matching filter field including matching filter information that characterizes the service named in the data string. The medium further includes code that, when executed, causes the apparatus to identify a service from the hash value using the receiver device.

### BRIEF DESCRIPTION OF THE DRAWINGS

FIG. 1 illustrates an example of a wireless communication system in which aspects of the present disclosure can be employed in accordance with an embodiment.

FIG. 2 illustrates a functional block diagram of a wireless device that can be employed within the wireless communication system of FIG. 1 in accordance with an embodiment.

FIG. 3 is a conceptual diagram for generation of a service ID that can be employed in the wireless communication system of FIG. 1 in accordance with an embodiment.

FIG. 4A illustrates a process for transmitting an unsolicited message with a hash value of a service ID of FIG. 3 in accordance with an embodiment.

FIG. 4B is a functional block diagram of a wireless device that can be employed to perform a process of FIG. 4A in the wireless communication system of FIG. 1.

FIG. 5A illustrates a process of receiving a message with a hash value of a service ID of FIG. 3 in accordance with an embodiment.

FIG. 5B is a functional block diagram of a wireless device that can be employed to perform a process of FIG. 5A in the wireless communication system of FIG. 1.

FIG. 6A is a process for comparing a reference hash with a received hash value using a service ID of FIG. 3 in accordance with an embodiment.

FIG. 6B is a functional block diagram of a wireless device that can be employed to perform a process of FIG. 6A in the wireless communication system of FIG. 1.

FIG. 7A is a process of generating a solicited message with a hash value of a service ID of FIG. 3 in accordance with an embodiment.

FIG. 7B is a functional block diagram of a wireless device that can be employed to perform a process of FIG. 7A in the wireless communication system of FIG. 1.

FIG. 8A illustrates a data structure in the form of a table for which a service ID of FIG. 3 can be utilized in accordance with an embodiment.

FIG. 8B illustrates a data structure in the form of a section of a packet in which a service ID of FIG. 3 can be utilized in accordance with an embodiment.

FIG. 9 illustrates a data structure in the form of a table for which a service ID of FIG. 3 can be utilized for a service discovery attribute in accordance with an embodiment.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies can include various types of wireless local area networks (WLANs). A WLAN can be used to interconnect nearby wireless devices together, employing widely used networking protocols. The various aspects described herein can apply to any communication standard, such as a wireless protocol.

In some implementations, a WLAN includes various wireless devices which are the components that access the wireless network. For example, there can be two types of wireless devices: access points (“APs”) and clients (also referred to as stations, or “STAs”). In general, an AP can serve as a hub or base station for the WLAN and a STA serves as a user of the WLAN. For example, a STA can be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA can also be used as an AP.

An access point (“AP”) can also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” can also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device or wireless device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Wireless devices, such as a group of STAs, for example, can be used for neighborhood aware networking (NAN), or social-WiFi networking. For example, various stations within the network can communicate on a wireless device to wireless device (e.g., peer-to-peer communications) basis with one another regarding applications that each of the STAs supports. It is desirable for a discovery protocol used in a social-WiFi network to enable STAs to advertise themselves (e.g., by sending discovery packets) as well as discover services provided by other STAs (e.g., by sending paging or query packets), while ensuring secure communication and low power consumption. It should be noted that a discovery packet can also be referred to as a discovery message or a discovery frame. It should also be noted that a paging or query packet can also be referred to as a paging or query message or a paging or query frame.

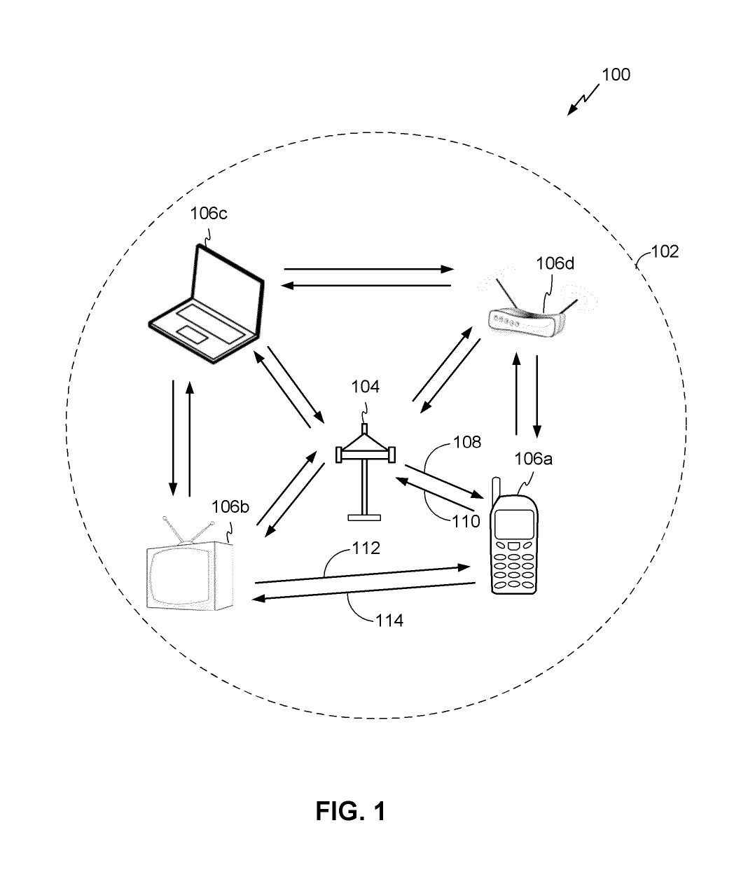

FIG. 1 illustrates an example of a wireless communication system 100 in which aspects of the present disclosure can be employed in accordance with an embodiment. The wireless communication system 100 can operate pursuant to a wireless standard, such as an 802.11 standard. The wireless communication system 100 can include an AP 104, which communicates with STAs 106. In some aspects, the wireless communication system 100 can include more than one AP. Additionally, the STAs 106 can communicate with other STAs 106. As an example, a first STA 106a can communicate with a second STA 106b. As another example, a first STA 106a can communicate with a third STA 106c although this communication link is not illustrated in FIG. 1.

A variety of processes and methods can be used for transmissions in the wireless communication system 100 between the AP 104 and the STAs 106 and between an individual STA, such as the first STA 106a, and another individual STA, such as the second STA 106b. For example, signals can be sent and received in accordance with OFDM/OFDMA techniques. If this is the case, the wireless communication system 100 can be referred to as an OFDM/OFDMA system. Alternatively, signals can be sent and received between the AP 104 and the STAs 106 and between an individual STA, such as the first STA 106a, and another individual STA, such as the second STA 106b, in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

A communication link can be established between STAs, such as during social-WiFi networking in a NAN. Some possible communication links between STAs are illustrated in FIG. 1. As an example, a communication link 112 can facilitate transmission from the first STA 106a to the second STA 106b. Another communication link 114 can facilitate transmission from the second STA 106b to the first STA 106a.

The AP 104 can act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

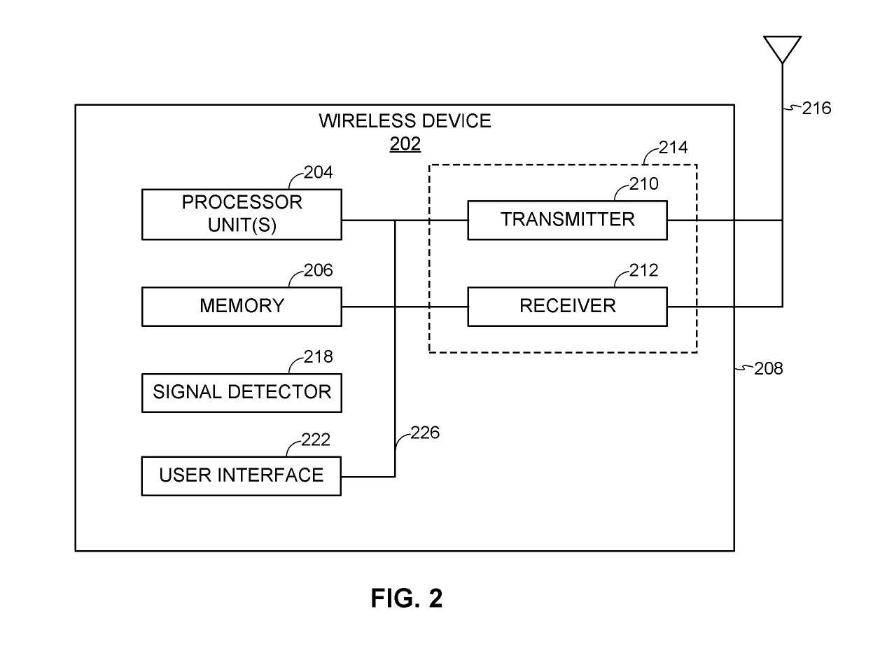

FIG. 2 illustrates various components that can be utilized in a wireless device 202 that can be employed within the wireless communication system 100 in accordance with an embodiment. The wireless device 202 is an example of a wireless device that can be configured to implement the various methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and/or a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas.

The transmitter 210 can be configured to wirelessly transmit packets having different packet types or functions. For example, the transmitter 210 can be configured to transmit packets of different types generated by the processor 204. When the wireless device 202 is implemented or used as an AP 104 or STA 106, the processor 204 can be configured to process packets of a plurality of different packet types. For example, the processor 204 can be configured to determine the type of packet and to process the packet and/or fields of the packet accordingly. When the wireless device 202 is implemented or used as an AP 104, the processor 204 can also be configured to select and generate one of a plurality of packet types. For example, the processor 204 can be configured to generate a discovery packet comprising a discovery message and to determine what type of packet information to use in a particular instance.

The receiver 212 can be configured to wirelessly receive packets having different packet types. In some aspects, the receiver 212 can be configured to detect a type of a packet used and to process the packet accordingly.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a packet for transmission. In some aspects, the packet can comprise a physical layer data unit (PPDU).

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. The components of the wireless device 202 can be coupled together or accept or provide inputs to each other using some other mechanism.

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

Systems and methods in accordance with various embodiments provide for a robust service identification (ID) for utilization in wireless devices (such as but not limited to STAs and APs) in neighbor aware networks (NAN). A service ID comprises information that can be utilized to identify a service. In certain embodiments, a service ID is generated as a hash value from a diversified input string. The term “string” may be used interchangeably with the term “data string.” A diversified input string is a input string whose characters are diversified and not set based only on a name of a service (such as but not limited to a input string whose characters are of both a name of a service and a type of message that the service ID is included in). The input string from which a service ID is generated can be diversified so that the combinations of characters utilized as an input to a hash function can also diversify the hash values utilized as a service ID. Compared with systems that utilize a service ID as a hash value from a input string of only a name of a service, the diversification of the input string enables for more efficient utilization of a hash function used in the determination of the service ID. Input string diversification can also decrease the chances of a collision occurring due to the same service ID being generated for different services.

In certain embodiments, wireless devices can provide services that other wireless devices can utilize. These services can be provided by software applications configured to execute on one wireless device while using information generated on another wireless device or information generated for another wireless device, such as but not limited to a game or social networking service. These services can be identified among wireless devices using a service ID within packetized communications among wireless devices. The size of a service ID can be variable, such as but not limited to six bytes.

As discussed above, input string diversification can be implemented to decrease a chance of collisions. A collision is a situation where two different services have the same service ID. A chance of a collision can increase as the number of services increases with a set size of a service ID used in packetized communications among wireless devices. A collision can be undesirable as a service may not be uniquely identified from a service ID. In certain embodiments, the likelihood of a collision can be decreased by generating a service ID as a hash value of a diversified input string that includes both a name of a service and information identifying a type of message that includes the service ID.

Input string diversification for collision avoidance can also provide for a more effective utilization of a hash function. A hash function is an algorithm that maps an input string of variable length to a hash value of a fixed length. Typically, a hash function is referentially transparent where a same input string should map to a same hash value. Thereby, vice versa, a same hash value can be indicative of a same input string utilized to generate the same hash value. In certain embodiments, a received service ID as a received hash value can be compared with a reference hash value to determine a name of a service and an anticipated type of message that the received service ID is associated with.

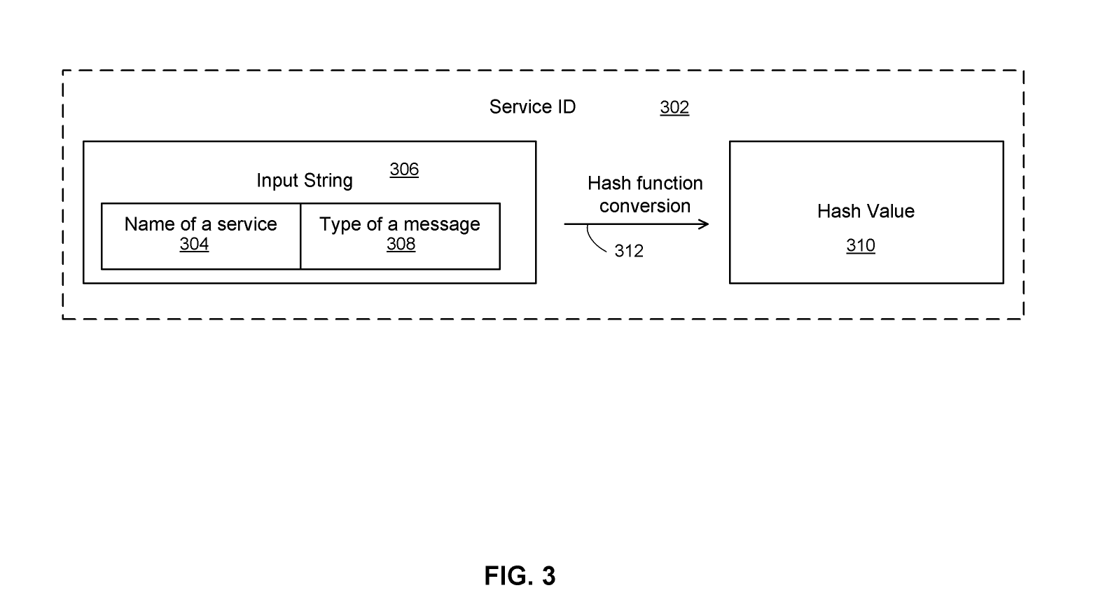

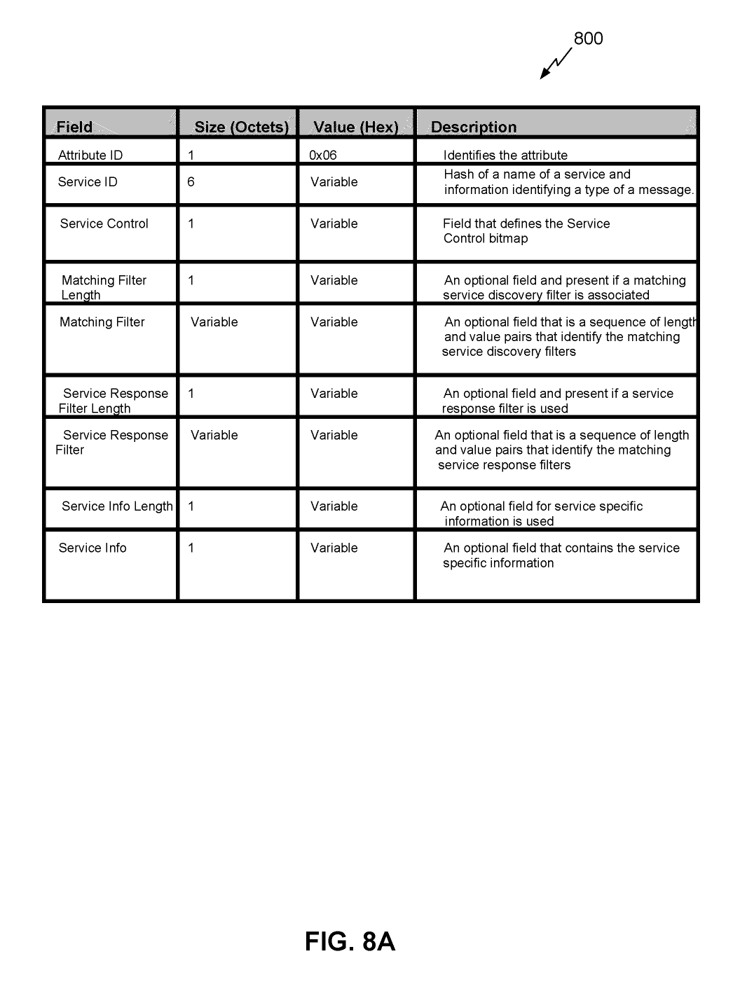

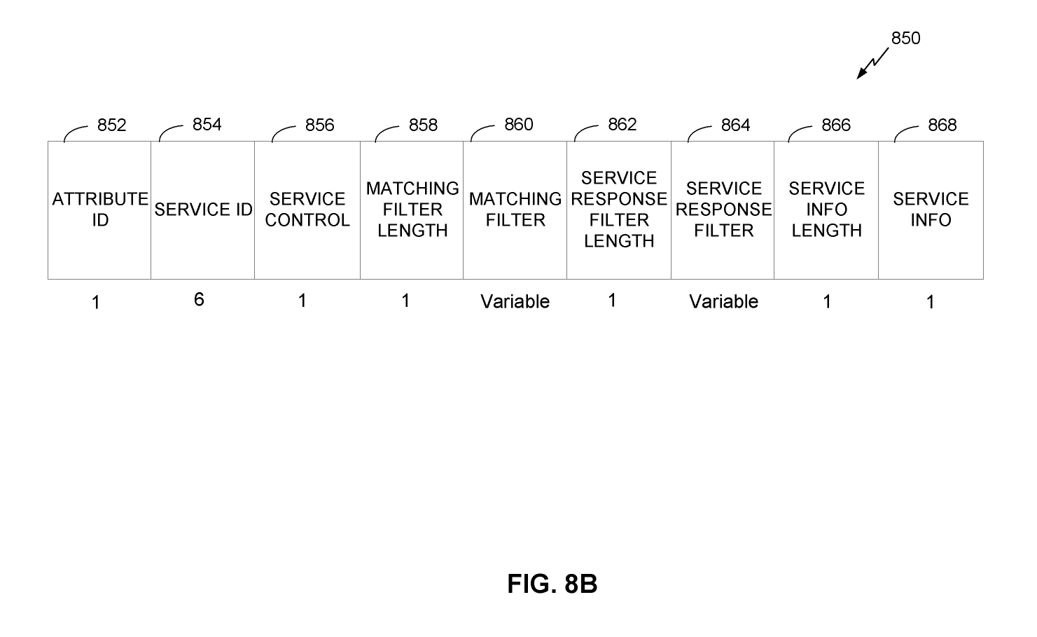

A conceptual diagram for generation of a service ID that can be employed in the wireless communication system of FIG. 1 is illustrated in FIG. 3 in accordance with an embodiment. The conceptual diagram illustrates that a diversified input string 306, as a string of characters including a name of a service 304 and a type of a message 308 that the service ID is included with, can be converted to a hash value 310 via a hash function 312. In certain embodiments, a diversified input string can be implemented in accordance with a reverse Domain Name Server (DNS) naming convention where a string of characters indicating a name of a service precedes a string of characters indicating a type of message (such as but not limited to “x1.x2.x3.publish”, “x1.x2.x3.subscribe”, “x1.x2.x3.publish_subscribe” or “x1.x2.x3.broadcast_advertise”, where “x1.x2.x3” is a string of characters indicating a name of a service and “publish”, “subscribe”, “publish_subscribe” and “broadcast_advertise” are each a string of characters indicating a type of a message). The service ID 302 can be used in packetized communications among wireless devices to identify a service. The service ID can be utilized in a field of a packet to identify a service, such as (but not limited to) an embodiment illustrated in FIGS. 8A and 8B.

Although an input string is discussed above with a name of a service preceded by a type of a message, a diversified input string can be implemented with characters in any order, such as but not limited to characters with a type of a message that precedes the name of a service or with the name of service interleaved with the type of a message in accordance with various embodiments. In certain embodiments, a diversified input string can be implemented in accordance with a Domain Name Server (DNS) naming convention where a string of characters indicating a type of message string precedes a string of characters indicating a name of a service (such as but not limited to “publish.x1.x2.x3”, “subscribe.x1.x2.x3”, “publish_subscribe.x1.x2.x3.” or “broadcast_advertise.x1.x2.x3”, where “x1.x2.x3” is a string of characters indicating a name of a service and “publish”, “subscribe”, “publish_subscribe” and “broadcast_advertise” are each a string of characters indicating a type of a message).

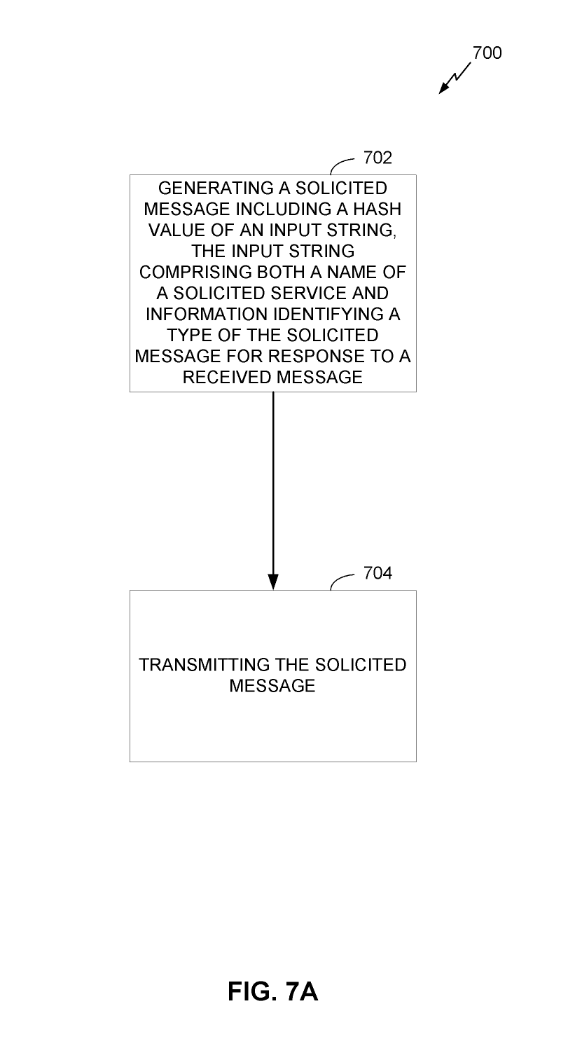

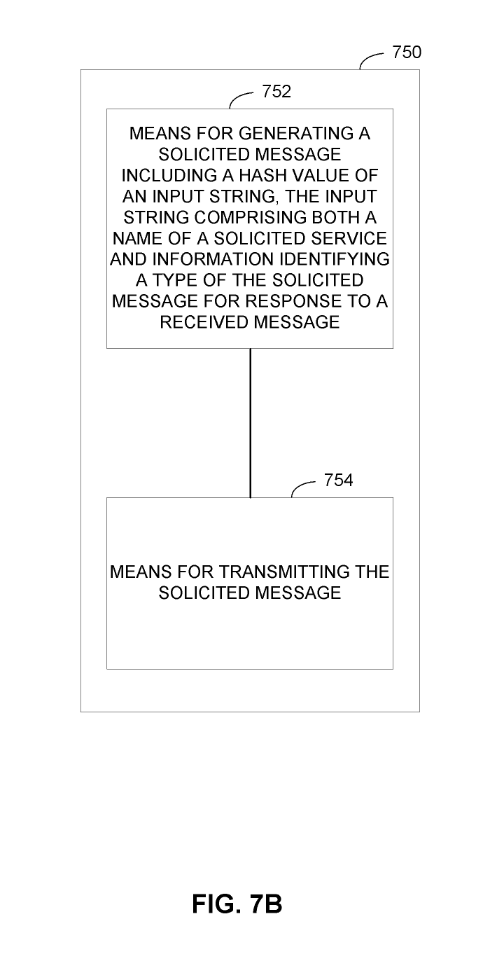

In various embodiments, a diversified input string can be utilized in the transmission of an unsolicited message from a wireless device. An unsolicited message can be a message not sent in response to another message with reference to a service. An unsolicited message can be compared with a solicited message sent in response to a message (such as information from a received message) described further below and discussed with FIGS. 7A and 7B. The unsolicited message can be sent in reference with a service identified with a service ID. The service ID can be included within a field of the unsolicited message in accordance with the type of packetized communication that the unsolicited message is sent with. In certain embodiments, an unsolicited message can include (but is not limited to) a publish message, a beacon frame or a query frame configured to announce a service to other wireless devices.

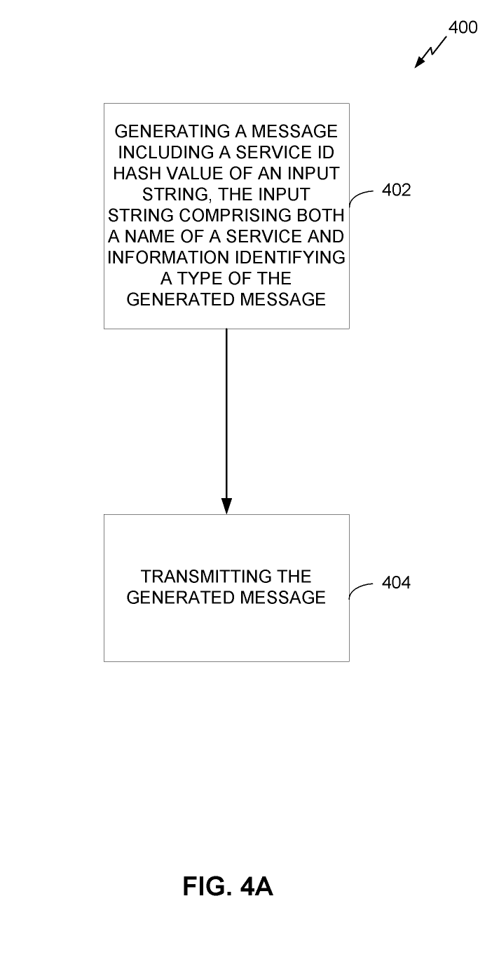

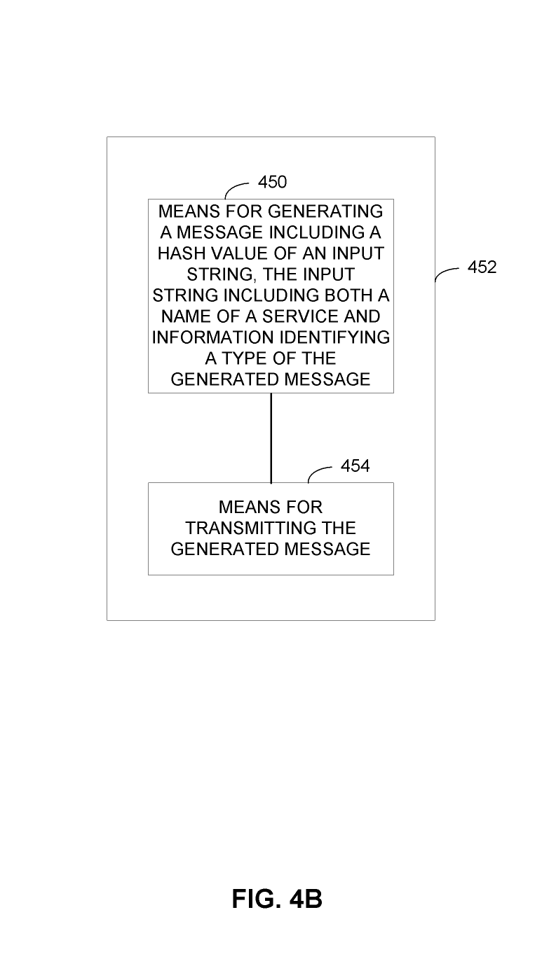

A process for transmitting an unsolicited message with a hash value of a service ID of FIG. 3 is illustrated in FIG. 4A in accordance with an embodiment. In certain embodiments, the process 400 can be performed by a wireless device, such as but not limited to a processor and a transmitter of a wireless device. Although the process 400 in FIG. 4A is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a generated message.

At block 402, an unsolicited message including a hash value of an input string can be generated via a wireless device. The input string can comprise both a name of a service and information identifying a type of the generated message. At block 404, the generated message can then be transmitted from the wireless device. In certain embodiments, the unsolicited message can be a publish message configured to announce a service to other wireless devices. The publish message can be configured with numerous fields related to the service to be advertised, including a field used to identify the service ID. A hash value of a diversified input string can be utilized as a service ID and entered into the field of a publish message to identify a service. The diversified input string can include information in addition to the name of the service, such as but not limited to the type of the message (publish) or any other information related to the publish message.

FIG. 4B is a functional block diagram of a wireless device that can be employed to perform a process of FIG. 4A in the wireless communication system of FIG. 1. The wireless device 452 can include a means 450 for generating a message including a hash value of a diversified input string. The diversified input string can include both a name of a service and information identifying a type of the generated message. In certain embodiments, the means 450 for generating a message can be configured to perform one or more of the functions with respect to block 402 (FIG. 4A). In various embodiments, the means 450 for generating a message can be implemented by a processor 204 (FIG. 2).

The wireless device further includes means 454 for transmitting the generated message. In certain embodiments, the means 454 for transmitting can be configured to perform one or more of the functions described above with respect to block 404 (FIG. 4A). In various embodiments, the means 454 for transmitting can be implemented by a transmitter 210 (FIG. 2).

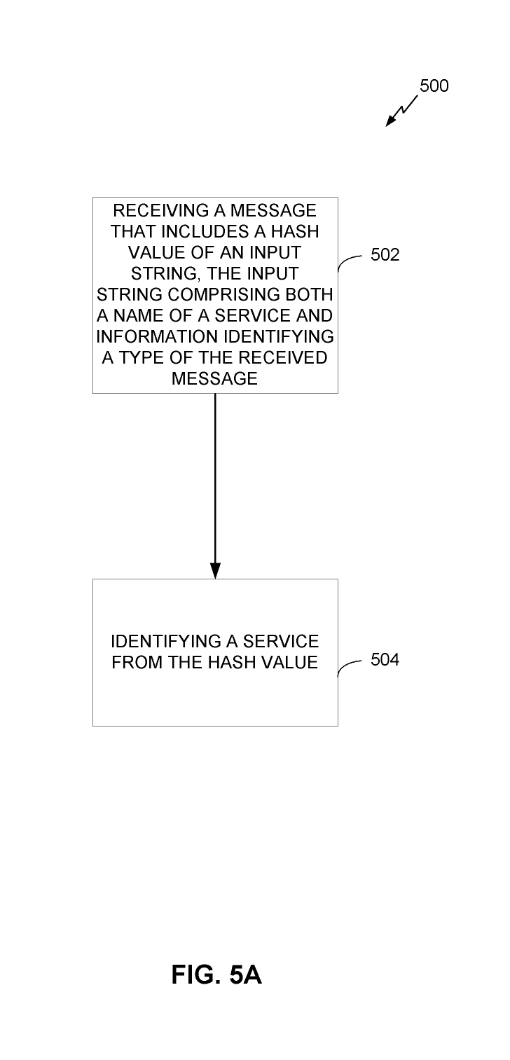

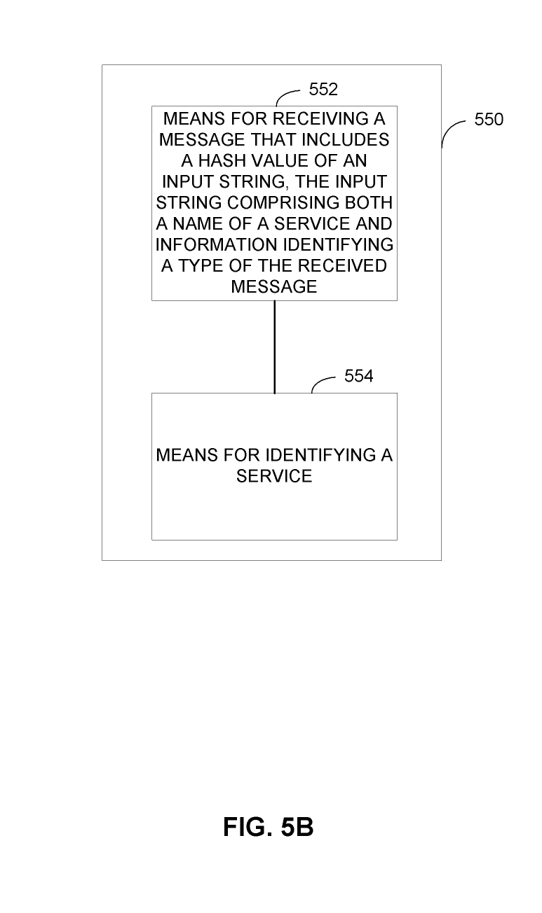

A process of receiving a message with a hash value of a service ID of FIG. 3 is illustrated in FIG. 5A in accordance with an embodiment. In certain embodiments, the process 500 can be performed by a wireless device, such as but not limited to a processor and a receiver of a wireless device. Although the process in FIG. 5A is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to receive and process a generated message.

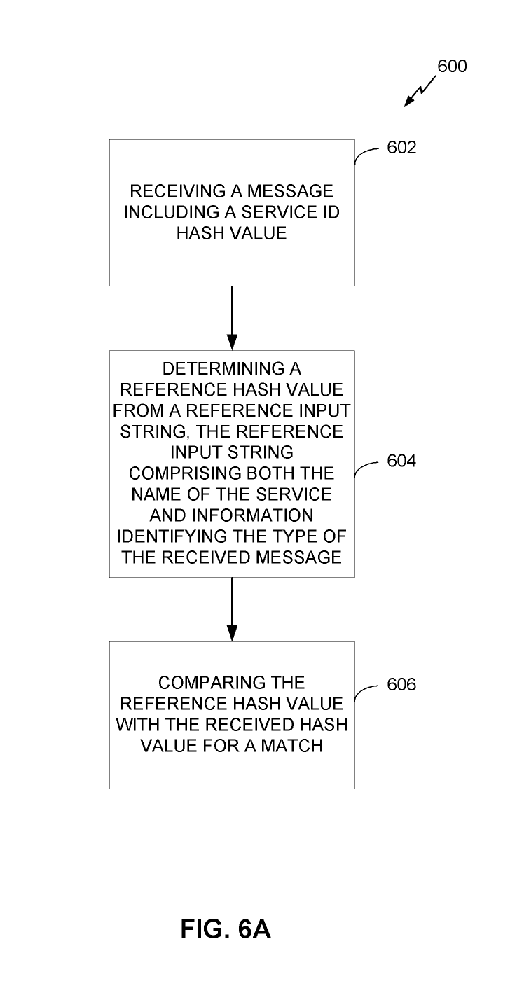

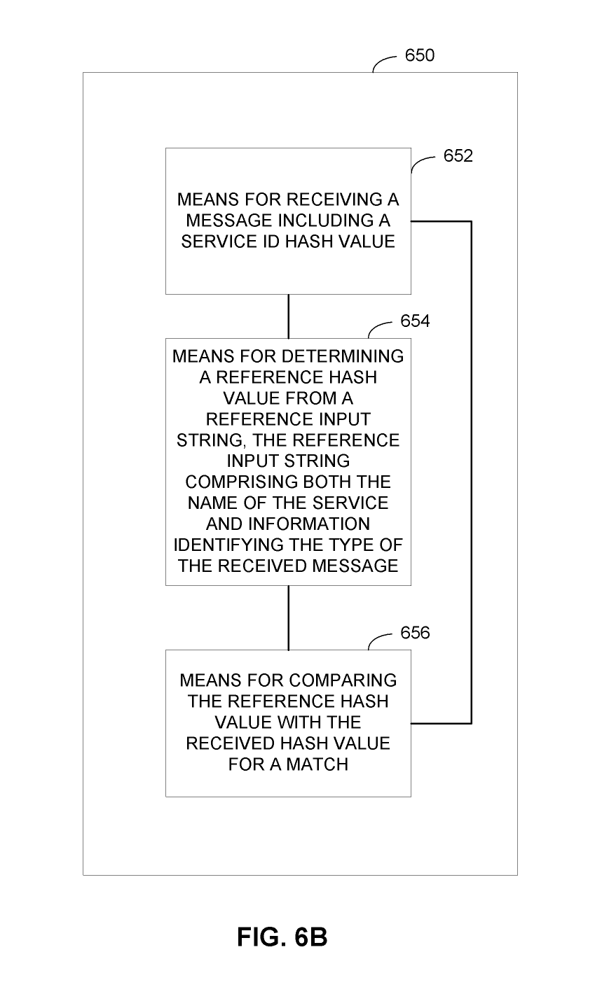

At block 502, a message that includes a hash value of a diversified input string as a service ID is received. The diversified input string can include both a name of a service and information identifying a type of the received message. The input string can comprise both a name of a service and information identifying a type of the generated message. At block 504, a service can be identified from the service ID hash value. Further disclosure of how a service can be identified from a service ID hash value can be found below and with a discussion of FIGS. 6A and 6B.

FIG. 5B is a functional block diagram of a wireless device that can be employed to perform a process of FIG. 5A in the wireless communication system of FIG. 1. The wireless device 550 can include a means 552 for receiving a message that comprises a hash value of a diversified input string. The diversified input string can include both a name of a service and information identifying a type of the generated message. In certain embodiments, the means 552 for receiving a message can be configured to perform one or more of the functions with respect to block 502 (FIG. 5A). In various embodiments, the means for receiving can be implemented by a receiver 212 (FIG. 2).

The wireless device further includes means 554 for identifying a service from the received message. In certain embodiments, the means 554 for identifying can be configured to perform one or more of the functions described above with respect to block 504 (FIG. 5A). In various embodiments, the means 554 for identifying can be implemented by a processor 204 (FIG. 2).

In a number of embodiments, a service can be identified from a service ID of a message. The messages can be received by a wireless device in connection with a service and with a field that includes the service ID. The received service ID, as a received hash value, can be compared with a reference service ID as a reference hash value to identify a service that the received message is related to. In certain embodiments, the reference hash value can be generated as a diversified input string that includes a name of a service (such as but not limited to a solicited service) and a type of a received message, (such as but not limited to a solicited message). In particular embodiments, these reference hash values can be stored as a look up table on a wireless device to easily identify a service using a service ID field of a received message.

A process for comparing a reference hash with a received hash value using a service ID of FIG. 3 in accordance with an embodiment is illustrated in FIG. 6A. In certain embodiments, the process can be performed by a wireless device, such as but not limited to a processor and receiver of a wireless device. Although the process in FIG. 6A is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to receive and process a received message.

At block 602, a message including a service ID as a hash value can be received via the wireless device. At block 604, a reference hash value can be determined from a reference input string. The reference input string can comprise both the name of a service and information identifying a type of a received message. At block 606, the reference hash value can be compared with the received hash value from the message including the service ID as a hash value for a match.

FIG. 6B is a functional block diagram of a wireless device that can be employed to perform a process of FIG. 6A in the wireless communication system of FIG. 1. The wireless device 650 can include a means 652 for receiving a message that comprises a hash value of a diversified input string. The diversified input string can include both a name of a service and information identifying a type of the generated message. In certain embodiments, the means 652 for receiving a message that comprises a hash value of a diversified input string can be configured to perform one or more of the functions with respect to block 602 (FIG. 6A). In various embodiments, the means for receiving a message that comprises a hash value of a diversified input string can be implemented by a receiver 212 (FIG. 2).

The wireless device 650 further includes means 654 for determining a reference hash value from a reference input string. In certain embodiments, the means 652 for determining a reference hash value from a reference input string can be configured to perform one or more of the functions described above with respect to block 604 (FIG. 6A). In various embodiments, the means for receiving can be implemented by a processor 204 (FIG. 2).

The wireless device 650 further includes means 656 for comparing the reference hash value with the received hash value for a match. In certain embodiments, the means 656 for comparing can be configured to perform one or more of the functions described above with respect to block 606 (FIG. 6A). In various embodiments, the means for comparing can be implemented by a processor 204 (FIG. 2).

In a number of embodiments, a message can be generated that is a solicited message generated in response to a received message. A solicited message can be any type of message generated in response to a received message, such as but not limited to a subscribe message or a response frame requesting a service. The service can be previously announced (such as but not limited to from a received publish message). Although solicited and unsolicited messages are described above, messages in accordance with various embodiments can also include aspects of both solicited and unsolicited messages such as a message that both announces a service (publish) and that requests a service (subscribe) in a publish and subscribe message.

A process of generating a solicited message with a hash value of a service ID of FIG. 3 is illustrated in FIG. 7A in accordance with an embodiment. In certain embodiments, the process can be performed by a wireless device, such as but not limited to a processor and a transmitter of a wireless device. Although the process in FIG. 7A is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a solicited message.

At block 702, a solicited message that includes a hash value of a diversified input string as a service ID is received. The diversified input string can include both a name of a solicited service and information identifying a type of the solicited message for response to a received message. At block 704, the solicited message can be transmitted.

FIG. 7B is a functional block diagram of a wireless device that can be employed to perform a process of FIG. 7A in the wireless communication system of FIG. 1. The wireless device 750 can include a means 752 for generating a solicited message that comprises a hash value of a diversified input string. The diversified input string can include both a name of a solicited service and information identifying a type of the solicited message for response to a received message. In certain embodiments, the means for generating a solicited message can be configured to perform one or more of the functions with respect to block 702 (FIG. 7A). In various embodiments, the means for generating can be implemented by a processor 204 (FIG. 2).

The wireless device further includes means for transmitting the solicited message. In certain embodiments, the means for transmitting can be configured to perform one or more of the functions described above with respect to block 704 (FIG. 7A). In various embodiments, the means for receiving can be implemented by a transmitter 210 (FIG. 2).

To illustrate how certain blocks in FIGS. 4A-7B can be implemented, in certain embodiments, a searching wireless device can be configured to search for a service. The searching wireless device can generate a subscribe message including a service ID as a hash value of an input string including both a name of a sought service and information identifying the type of the generated subscribe message to be a subscribe message (blocks 402 and 450). The searching wireless device can also transmit the generated message (blocks 404 and 454).

A service providing device can receive the subscribe message including the service ID as the hash value of the input string including both the name of the sought service and information identifying the type of the subscribe message to be a subscribe message (blocks 502 and 504). The service providing device can identify a service from the hash value (blocks 504 and 554). Specifically, the service providing device can be configured to determine a reference hash value from a reference input string, the reference input string including both the name of the sought service and information identifying the type of the subscribe message to be a subscribe message (blocks 604 and 654). The service providing device can then compare the reference hash value to the hash value of the subscribe message for a match (blocks 606 and 656). The service providing device can also generate a solicited publish message including a hash value of a service ID including both the name of the sought service and information identifying the type of the solicited publish message to be a solicited publish message (blocks 702 and 752). The service providing device can then transmit the solicited publish message (blocks 704 and 754).

A data structure in the form of a table for which a service ID of FIG. 3 can be utilized in accordance with an embodiment is illustrated in FIG. 8A. The table 800 illustrates how different fields of a packet can be communicated among wireless devices in a NAN network concerning an attribute. Any type of attribute can be utilized in accordance with various embodiments, such as but not limited to a service discovery attribute or a service identifier attribute. The packet can include a field for an attribute ID that identifies the attribute. The size of the field can be of one byte and the value of this field can be 0x06 (Hex). The packet can also include a service ID field that contains a hash of a diversified input string, such as but not limited to a name of a service and information identifying a type of a message. The service ID field can be of six bytes and of a variable value. The packet can also include a service control field of one byte with a variable value that defines a service control bitmap. The packet can also include a matching filter length field of one bye and a variable value which is an optional field present if a matching service discovery filter is associated with the attribute. A matching filter field can also be included of a variable size and variable value. A service response filter length field can also be included of one byte and a variable value. The service response filter length field can be an optional field and present if a service response filter is used. A service response filter can also be utilized of a variable size and variable value which is a sequence of length and value pairs that identify the matching service response filters. An optional service info length field can also be utilized of one byte and variable value for service specific information. A service information field can also be utilized of one byte and variable value which contains the service specific information.

A data structure in the form of a section of a packet in which a service ID of FIG. 3 can be utilized in accordance with an embodiment is illustrated in FIG. 8B. The data structure 850 is for a packet with an attribute ID field 852, service ID field 854, service control field 856, matching filter length field 858, matching filter field 860, service response filter length field 862, service response filter field 864, service information length field 866 and service information field 868. The attribute ID field 852 can be of one byte, the service ID field 854 can be of six bytes, the service control field 856 can be of one byte, the matching filter length field 858 can be of one byte, the matching filter field 860 can be of variable bytes, the service response filter length field 862 can be of one byte, the service response filter field 864 can be of variable bytes, the service information length field 866 can be of one byte and the service information field 868 can be of one byte.

In certain embodiments, further robustness for the service ID can be implemented by including matching filter information in the matching filter field. The matching filter information may be any information that characterizes a service identifiable using the service ID in the service ID field. The matching filter information that characterizes the service in the matching filter field can provide the same information as the service ID in the service ID field or may provide different information than the service ID in the service ID field, such as by providing additional information in the matching filter field to more specifically identify a service beyond the information provided in the service ID field. Thereby, a further check can be made concerning a service ID beyond just having information identifying a service in a packet within the service ID field of the packet.

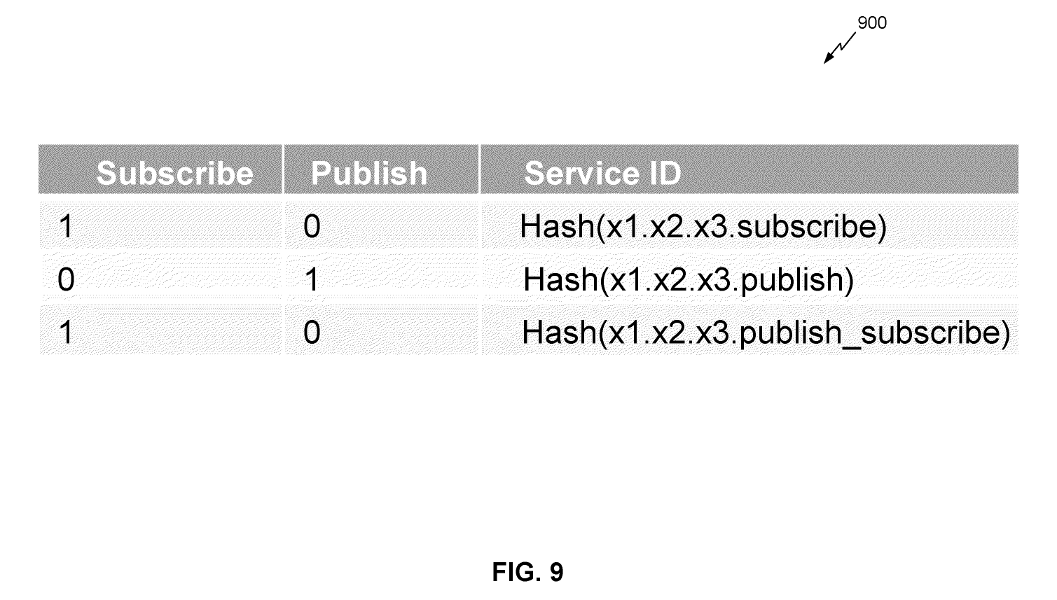

A data structure in the form of a table for which a service ID of FIG. 3 can be utilized for a service discovery attribute in accordance with an embodiment is illustrated in FIG. 9. The table 900 illustrates certain values in certain fields of a service discovery attribute. When a message is a subscribe message, a field associated with identifying a subscribe message is “1”, a field associated with identifying a publish message is “0” and a field for a service ID includes a hash value of an input string of both a name of a service and information identifying a type of the message (where “x1.x2.x3” represents a name of a service and “subscribe” is information identifying a type of the message). Similarly, when a message is a publish message, a field associated with identifying a subscribe message is “0”, a field associated with identifying a publish message is “1” and a field for a service ID includes a hash value of an input string of both a name of a service and information identifying a type of the message (where “x1.x2.x3” represents a name of a service and “publish” is information identifying a type of the message). Lastly, when a message is a publish and subscribe message, a field associated with identifying a subscribe message is “1”, a field associated with identifying a publish message is “0” and a field for a service ID includes a hash value of an input string of both a name of a service and information identifying a type of the message (where “x1.x2.x3” represents a name of a service and “publish_subscribe” is information identifying a type of the message).

It should be understood that any reference to an element herein using a designation such as “first,” “second,” and so forth does not generally limit the quantity or order of those elements. Rather, these designations can be used herein as a convenient method of distinguishing between two or more elements or instances of an element. Thus, a reference to first and second elements does not mean that only two elements can be employed there or that the first element can precede the second element in some manner. Also, unless stated otherwise a set of elements can include one or more elements.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein can be implemented as electronic hardware (e.g., a digital implementation, an analog implementation, or a combination of the two, which can be designed using source coding or some other technique), various forms of program or design code incorporating instructions (which can be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with the above FIGS. can be implemented within or performed by an integrated circuit (IC), an access terminal, or an access point. The IC can include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and can execute codes or instructions that reside within the IC, outside of the IC, or both. The logical blocks, modules, and circuits can include antennas and/or transceivers to communicate with various components within the network or within the device. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. The functionality of the modules can be implemented in some other manner as taught herein. The functionality described herein (e.g., with regard to one or more of the accompanying figures) can correspond in some aspects to similarly designated “means for” functionality in the appended claims.

If implemented in software, the functions can be stored on or transmitted over as one or more instructions or code on a computer-readable medium. The steps of a method or algorithm disclosed herein can be implemented in a processor-executable software module which can reside on a computer-readable medium. Computer-readable media includes both computer storage media and communication media including any medium that can be enabled to transfer a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and instructions on a machine readable medium and computer-readable medium, which can be incorporated into a computer program product.

It is understood that any specific order or hierarchy of steps in any disclosed process is an example of a sample approach. Based upon design preferences, it is understood that the specific order or hierarchy of steps in the processes can be rearranged while remaining within the scope of the present disclosure. The accompanying method claims present elements of the various steps in a sample order, and are not meant to be limited to the specific order or hierarchy presented.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of transmitting service information in a wireless neighborhood aware network, comprising:
generating, via a wireless device, a message including a hash value of a data string, the data string comprising both a name of a service and information identifying a type of the message, the message further including a matching filter field including matching filter information that characterizes the service named in the data string; and
transmitting the message.

2. The method of claim 1, comprising:
receiving, via the wireless device, a solicited message including a solicited hash value;
determining a reference hash value from a reference data string, the reference data string including both a name of a solicited service and information identifying a type of the solicited message;
comparing the reference hash value with the solicited hash value for a match.

3. The method of claim 1, wherein the message includes the hash value in a field of the message for identification of the service as a service identification.

4. The method of claim 1, wherein the data string includes a string of characters, wherein the name of the service precedes the information identifying the type of the message.

5. The method of claim 1, wherein the type of the message is a publish message configured to announce the service.

6. The method of claim 1, wherein the type of the message is a subscribe message for requesting the service.

7. The method of claim 1, wherein the type of the message is a publish and subscribe message.

8. The method of claim 1, wherein the message includes information identifying the type of the message apart from the hash value included in a field of the message for identifying the type of the message.

9. The method of claim 1, wherein the name of the service is the name of a solicited service.

10. The method of claim 1, wherein the message is included in a beacon frame.

11. The method of claim 1, wherein the hash value is in a service discovery attribute

12. The method of claim 1, wherein the hash value is in a service identifier attribute.

13. The method of claim 1, wherein the matching filter field is in a query frame.

14. The method of claim 1, wherein the matching filter field is in a response frame.

15. The method of claim 1, wherein the matching filter information identifies the service named in the data string with information different than the name of the service.

16. The method of claim 1, wherein the matching filter information is the name of the service in the data string.

17. The method of claim 1, wherein the matching filter information includes a specific name of the service identifying the service more specifically than the name of the service in the data string.

18. A method of receiving service information in a wireless neighborhood aware network, comprising:
receiving, via a wireless device, a message that includes a hash value of a data string, the data string including both a name of a service and information identifying a type of the message, the message further including a matching filter field including matching filter information that characterizes the service named in the data string; and
identifying the service from the hash value.

19. The method of claim 18, wherein the identifying the service from the hash value comprises:
determining a reference hash value from a reference data string, the reference data string including both the name of the service and information identifying the type of the message;
comparing the reference hash value with the hash value for a match.

20. The method of claim 18, comprising:
generating, via a wireless device, a solicited message including a solicited hash value of a solicited data string, the solicited data string including both a name of a solicited service and information identifying a type of the solicited message for response to the message; and
transmitting the solicited message.

21. The method of claim 18, wherein the type of the message is a publish message configured to announce the service.

22. The method of claim 18, wherein the type of the message is a subscribe message for requesting the service.

23. The method of claim 18, wherein the type of the message is a publish and subscribe message.

24. An apparatus for transmitting service information in a wireless neighborhood aware network, comprising:
a processor configured to generate a message, wherein the message includes a hash value of a data string that includes both the name of a service and information identifying a type of the message, the message further includes a matching filter field including matching filter information that characterizes the service named in the data string; and
a transmitter configured to transmit the message.

25. The apparatus of claim 24, comprising:
a receiver configure to receive a solicited message, the solicited message including a solicited hash value, wherein:
the processor is configured to determine a reference hash value from a reference data string, the reference data string including both a name of a solicited service and information identifying a type of a solicited message; and
compare the reference hash value with the solicited hash value for a match.

26. The apparatus of claim 24, wherein the hash value is in a field of the message for identification of the service as a service identification.

27. The apparatus of claim 24, wherein the message includes information identifying the type of the message apart from the hash value stored in a field of the message for identifying the type of the message.

28. An apparatus for receiving service information in a wireless neighborhood aware network, comprising:
a receiver configured to receive a message including a hash value of a data string, the data string including both a name of a service and information identifying a type of the message, the message further includes a matching filter field including matching filter information that characterizes the service named in the data string; and
a processor configured to use the hash value to identify the service.

29. The apparatus of claim 28, wherein the processor is configured to identify the service by determining a reference hash value from a reference data string, the reference data string including both the name of the service and information identifying the type of the message; and comparing the reference hash value with the hash value for a match.

30. The apparatus of claim 28, comprising:
a transmitter, wherein:
the processor is configured to generate a solicited message including a solicited hash value of a solicited data string, the solicited data string including both a name of a solicited service and information identifying a type of the solicited message for response to the message; and
the transmitter is configured to transmit the solicited message.
